(19) United States
(12) Patent Application Publication
(10) Pub. No.: US 2005/0218535 A1
(43) Pub. Date: Oct. 6, 2005

(54) Indirect evaporative cooling mechanism

(76) Inventors: Valeriy Maisotsenko, Auroroa, CO (US); Leland E. Gillan, Denver, CO (US); Timothy L. Heaton, Arvada, CO (US); Alan D. Gillan, Denver, CO (US)

Correspondence Address: JENNIFER L. BALES, MOUNTAIN VIEW PLAZA, 1520 EUCLID CIRCLE, LAFAYETTE, CO, 80026-1250, US

(21) Appl. No.: 11/095,106

(22) Filed: Mar. 31, 2005

Related U.S. Application Data
(63) Continuation-in-part of application No. 10/213,002, filed on Aug. 5, 2002.

(51) Int. Cl. F25D 17/06; F02M 31/00; F02M 23/14

(52) U.S. Cl. 261/153

(57) ABSTRACT

The present invention relates to methods for indirect evaporative air-cooling with the use of plates, heat exchangers and feeder wicks—of the indirect evaporative type. Several components for an indirect evaporative heat exchanger described as follows: A plate for an indirect evaporative heat exchanger where the plate is made of laminate material having one sheet of wicking material for wet zone(s) and the other of a water proof plastic material for the dry zone(s). An evaporative heat exchanger is created by assembling the plates forming spacing for wet channels, (they are created by the wet zone of the plates,) and dry channels, (they are created by the dry zone of the plates,) with channel guides or corrugated plates. The spacing between the plates is defined to reduce pressure drop for increased airflow. A feeder wick system creates the wetting of the wet channels without excess water. Sometimes the wet zone of the plate can be made of a membrane material where the opposite side of this membrane material is covered by a solid desiccant creating the wet zone of this desiccant plate. An indirect evaporative heat exchanger that is created by assembling both wick coated with plastic plates and desiccant plates, can realize not only the evaporative cooling but also the dehumidification of air.

The present application is a Continuation-in-Part of U.S. patent application Ser. No. 10/213,002, filed Aug. 5, 2002.

### FIELD OF ART

The present invention relates to a method of indirect evaporative cooling with specific improvements to the apparatus, the heat exchangers, the fluid providing apparatus. The new improved apparatus described herein enable the use of evaporative coolers in efficient, economical and a variety of environments.

### BACKGROUND OF THE INVENTION

The subject invention improves the efficiency, economic feasibility, and productivity of evaporative coolers. The specific improvements apply to the heat exchanger plates, and the use of wick methods to improve distribution of fluids and also aid the evaporative action.

Evaporative cooling, as a means to cool, is a common method with a long history. The available methods and apparatus have not addressed some of the limitations and as a result the use of evaporative cooling has been limited in some circumstances. By most current methods the maximum cool temperature that may be reached is the wet bulb temperature. The limited maximum cooling that can occur has proved to be commercial disadvantages to the current systems. The apparatus contained in this application addresses many of these disadvantages.

Presently U.S. Pat. No. 4,544,513 discloses a combination direct and indirect evaporative media consisting of relatively thick plastic molding. The plastic is molded with ridges to provide stability and rigidity to the plastic. Among the drawbacks to this method is the poor heat transfer that occurs with plastic of this thickness.

Another U.S. Pat. No. 4,758,385, makes use of heat exchanger plates consisting of stamped metal covered with a wick like material. The disadvantage of this system is the inability to control the heat transfer in a desired way. In addition to the heat transfer problems, the subject of this patent has the drawbacks of the weight, cost and potential corrosion of metal.

Other shortcomings of previous designs are addressed by the recognition as set forth in this application that certain spacing has a desirable benefit to the overall efficiency of the cooler because of reduced pressure drops over the inlet to output path of fluid flow. The spacers and ridges addressed by this application not only perform the function of providing channels or paths but also are designed to improve the working pressure drops so as to minimize this inefficiency.

### SUMMARY OF THE INVENTION

The within invention improves on certain elements of evaporative cooling systems. Indirect evaporative cooling systems increase its efficiency, economy and productivity by the additions of the novel structures disclose here. The elements of these improvements address the heat exchange system, the use and selection of fluids and flow directions, the method of distributing evaporating fluids and other elements disclosed here in.

The particulars are directed to new structural elements that are sheets that are then formed as a stack or repetitive combination of sheets to create the cooling and heat transfer surfaces. The structure embodies thin plates or composite sheets made up of a layer that holds or wicks water or another fluid that is then released by way of evaporation. At least a portion of one side is a plastic or similar material or treatment that has low permeability to water or other evaporating fluid. The combination of these two provide heat conductivity across the barrier while still maintaining control of the fluid and any result in humidity to the air or other fluids that are being cooled. Also, the structure makes use of the physical characteristics of the materials to improve the mechanism.

The structure as illustrated can take the form of flat plates, of corrugated plates, or other shapes. The plates, if flat, may be separated by the use of an elastimer, adhesive, by rods, or by structure formed or built into the plates themselves. The flow of air or other fluid to be cooled may be by parallel flow, cross flow at any desired angle, or counterflow between adjacent spaces, one being for working air and one being for product fluid.

The improvement to the evaporating fluid distribution is by a feeder wick. This insures that all of the evaporative layers will get adequate wetting, but not so much that evaporation will be curtailed. Alternately, a reservoir system is disclosed.

### BRIEF DESCRIPTION OF THE DRAWINGS

FIG. 1, plate of wick material and thin plastic film.

FIG. 2, corrugated plate of wick material and thin plastic film.

FIG. 3, indirect evaporative heat exchanger with plates from FIG. 1 stacked together, (feeder wick system is not shown).

FIG. 4, indirect evaporative heat exchanger with corrugated plates from FIG. 2 stacked together, (feeder wick system is not shown).

FIG. 4a, indirect evaporative heat exchanger with corrugated plates from FIG. 2 stacked together with crimped and glued edges to separate channels.

FIG. 5, indirect evaporative heat exchanger with channel guides.

FIG. 6, indirect evaporative heat exchanger with corrugated channel guides.

FIG. 7, feeder wick in a stack of panels with water entering from the top through a tube.

FIG. 8, feeder wick in a stack of panels with water being drawn from a reservoir with water at the bottom.

FIG. 9, feeder wick in a stack of panels with water entering from the bottom through a tube placed in the center feeder wick.

### DETAILED DESCRIPTION OF THE INVENTION

One component of an evaporative cooler system that is herein disclosed as an improved and novel component is the heat exchange surface. In prior systems of evaporative cooling the heat exchanger surface often was metal sheeting or plastic sheeting. As disclosed in the referenced patents the use of a metal sheet with a fluid layer has been used. The within invention makes use of a combination or composite sheeting or plate (1), but accomplishes and improves efficiency due to its selection and structure of materials.

The composite sheeting that is used in the within disclosure consists of two layers. The water-conducting layer that we call the wick layer (2), can be made of cellulose, polyester or other similar materials such as polypropylene or fiberglass. The preferred embodiment is of cellulose. Cellulose also has good wicking capabilities but may need structural or form support to keep it in a proper shape when it is wet, and to keep it from deforming when drying. In some embodiments, the plates are “nonstructural,” meaning that they do not have the ability to retain their formed shape without support when they are wet. The plates might be formed of a wicking material like cellulose fiber paper backed by a material that is impermeable to the evaporative liquid such as polyethylene. The structural support for these nonstructural plates is provided by elongated channel guides disposed between the plates and connecting the plates. Preferably the channel guides also guide fluids/gases between adjacent plates. The channel guides on the wet sides are not parallel to the channel guides on the dry sides, in order to provide better structural support. FIG. 5 shows an example of such an embodiment.

The structural support may be by rigid nonfiber or cellulose structural pieces or by structure inherent in the fiber layer such as by corrugations, ridges that are stamped or formed into the fiber material or other integral structural support means. Polyester has the advantages of good dimensional stability when dry and wet and good wicking capabilities.

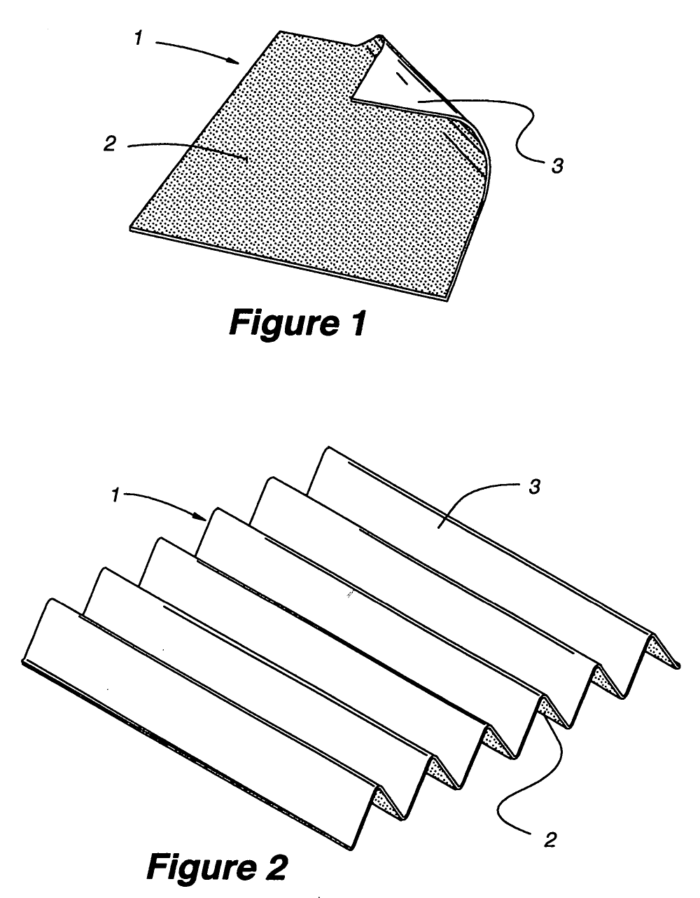

As shown in FIG. 1, the low permeable layer, plastic (3) or any other suitable composition that is impervious to the fluids and has low heat conductivity except across small thicknesses, is adjacent to the fiber layer. It may be laminated, painted or by adhesion attached to the fiber layer. The object is to have thin composite sheets for use in evaporative coolers as the heat transfer surface. The advantage of plastic is that it is inexpensive, may be formed in very thin sheets, and the assembly with the fiber layer is easy and inexpensive.

In some embodiments the plastic layer may be on both sides of the wick layer. Additionally the plastic layer may extend over a limited portion of one side of the wick layer.

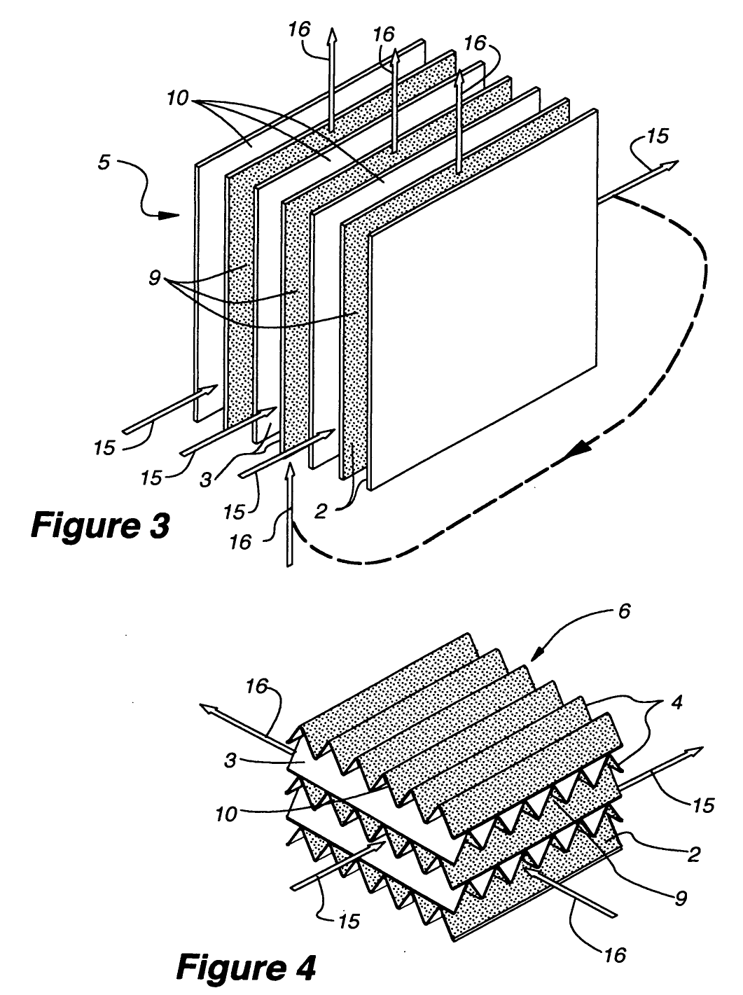

The plate (1) shown in FIG. 1 has the multiple layers described with the plastic or low permeable layer (3) covering one side of the plate. The evaporative cooler assembly is composed of numerous plates such as the plate organized and arranged in a particular way as will be described later in this application. FIG. 3 shows multiple number of composite plates (5) assembled as they may be assembled for the cooler.

The use of the low permeability layer (3), such as plastic on top of the wick layer has the following advantages: because the wick layer, either through itself or by added structural supports, such as with channel guides, the plastic or low permeability layer may be very thin. In some circumstances it may be merely painted onto the wick layer (2). The thinness of the low permeability layer allows good heat transfer for the heat differential across the low permeability layer. But because the low permeability material such as plastic does not readily transfer heat, except across very thin layers, the heat transfer along the surface of the plastic layer will be poor. The heat transfer perpendicularly through the plastic layer will be good while transferability horizontally along the surface of the plastic layer will be very poor.

The result of this differential heat transferability is that heat will transfer from one side of the plate to the other along the interface of the plastic while at the same time heat will not readily transfer along the surface. The result is that discrete temperatures and a temperature differential can occur at different points in the plate and it will not be averaged due to the heat transfer by the plate.

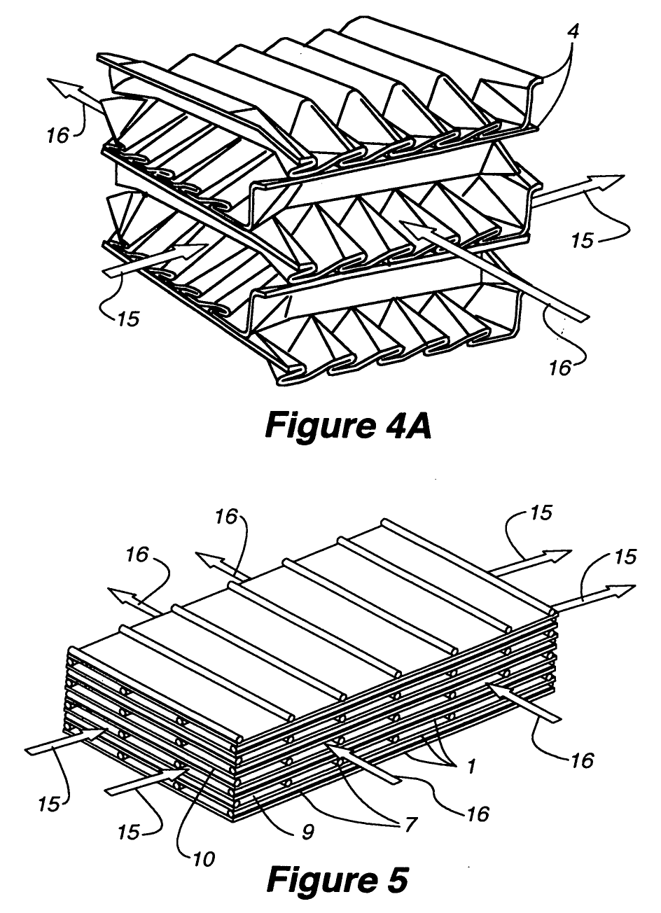

Alternative embodiments are shown in FIG. 2 where the composite plate is of a corrugated shape (4). This corrugated plate, by the corrugations, has structural stability. Similar to the flat plates of FIG. 1, the use of corrugated plates (4) such as FIG. 2 are assembled into a stack of multiple plates which are shown in FIG. 4. The details of the assembly are similar whether the structural elements are flat plates or corrugated plates.

As the first embodiment flat plates such as FIG. 1 are assembled into a stack as shown in FIG. 3. The first plate in FIG. 3 is made of the wick layer with a plastic layer. This wick layer will be moistened or have fluid in it and the evaporation from that fluid will cool the wick layer as well as any adjacent air. The second plate in FIG. 3 is a composite sheet of the plastic layer (3) and the wick layer such as (1). The visible part of the second plate is the wick layer. On the opposite side of the second sheet is the plastic layer.

The third plate in FIG. 3 is also a composite sheet. The plastic layer is visible and the wick layer is not visible. The fourth plate, also a composite sheet, has the wick layer visible and the plastic layer not visible. The fifth plate is a composite sheet with the plastic layer visible and the wick layer not visible.

There is spacing between adjacent sheets to allow fluid such as air to move between the plates. The spacing may be maintained by rods, beads, or other structural elements added to or inherent within the assembly. The assembly of the plates is as follows: each composite plate has as its surface in the space between plates matches the opposing surface. Thus, within the space between two adjacent plates there will be similar layers from the two adjacent plates. They will be either both wick layers or both plastic layers. For those areas where the adjacent layers are plastic, they are called the dry channels (10). For those spaces with adjacent wick layers we call them the wet channels (9).

Another element of the structure of the assembled sheets as in FIG. 3 is that the spacing structure is oriented in order to aid the air or fluid flow that is being used. In the example of FIG. 3 the flow in the dry channel is illustrated. The flow in the adjoining wet channel is in a different direction and oriented at, for example, 90 degrees from the flow direction of the dry channel. The further expanded view of two adjacent sheets is illustrated in FIG. 5. It uses the composite plates with plastic layers and wick layers with the plastic layers of each other forming the product channel, or the dry channel (10) and the wick layers opposing each other in the working air channel, or the wet channel (9). The separation of the plates is by way of guides (7) to keep the spacing between the first and second plates and between the second and third plates. The orientation or direction of the fluid flow in the product air (15) is in a desired and directed way. The guides keep the product air within its bounds. In the next adjacent space where the working air space is created, above or below the product air layer, the guides are located at, for example, 90 degrees, opposed to the guides in the product fluid air to allow the fluid or working air to flow in its desired direction or cross flow in the embodiment.

The spacing between plates is preferred to be 1.57 mm to 1.83 mm, 2.17 mm to 2.33 mm, 2.16 mm to 2.87 mm, or 3.13 mm to 3.39 mm. In some preferred embodiments the plates are spaced apart between 1.5 mm and 3.5 mm, 1.5 mm and 1.85 mm, 2.0 mm and 2.35 mm, 2.1 mm and 2.35 mm, 2.1 mm and 2.9 mm, or 3.1 mm and 3.5 mm. These channel spacing dimensions have proven by experiment to reduce the pressure drop across plates from 1% up to 15% as compared to separation outside of these bracketed values. Due to the increased flow rates, with decreased pressure drops small, dust particles tend to pass through the channels 9 and 10 more easily, keeping the plates clean. In addition, tests have shown deposit build up is reduced along the plate surfaces due to the transverse quarter wave, increasing the dynamic energy of the flow in the direction of the flow at the boundary layer; where the transverse wave is described in Maisotsenko U.S. Pat. No. 5,812,423. Different distances between plates are needed depending on the application and flow rates desired, so several wet (9) and dry (10) channel sizes have been designed.

An alternative embodiment uses corrugated sheets such as shown in FIG. 2. The corrugated plate also is a composite sheet made of a wick layer and a plastic layer. The assembly of the corrugated plates is illustrated in FIG. 4. The corrugations form the guides for the flow of air and thus form channels. The channels are maintained by having the corrugations of adjoining plates oriented such that they are not parallel and do not nest with the adjoining plate. The orientation in FIG. 4 is with the corrugations at right angles between adjacent plates. This angle could be any angle so long as it is not parallel.

In corrugated assemblies there may be additional closure of the perimeter edges to ensure that the airflow continues as desired and does not exit at other than the designated locations. The sealant may be by adhesive, heat, glue, crimping such as in FIG. 4A or any other means.

As discussed in the corrugated plates the orientation of the flow for the adjacent flat sheets may be in any desired angle. The illustration contained in FIG. 3 shows angles of 90 degrees.

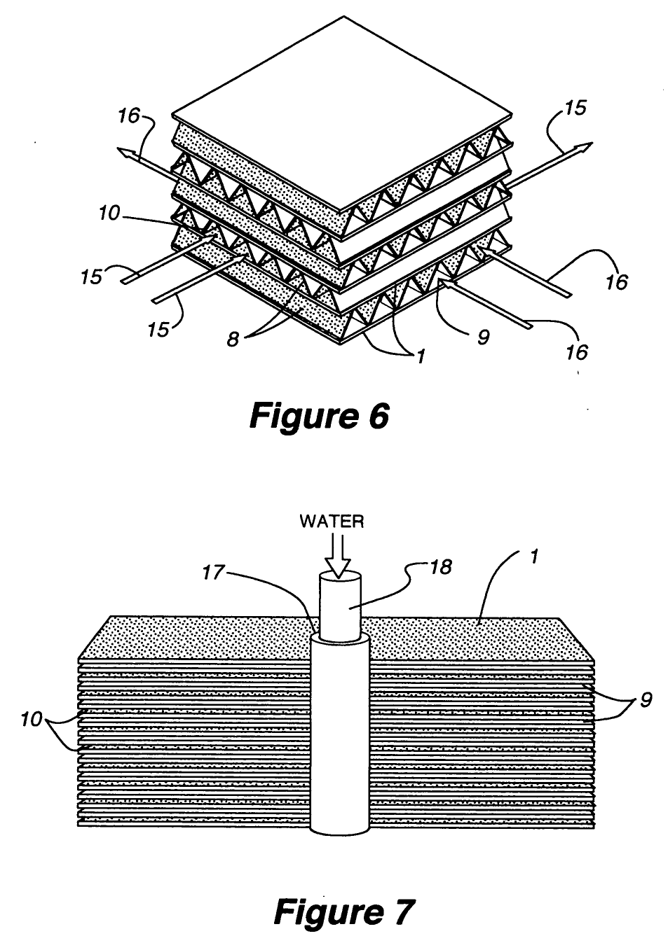

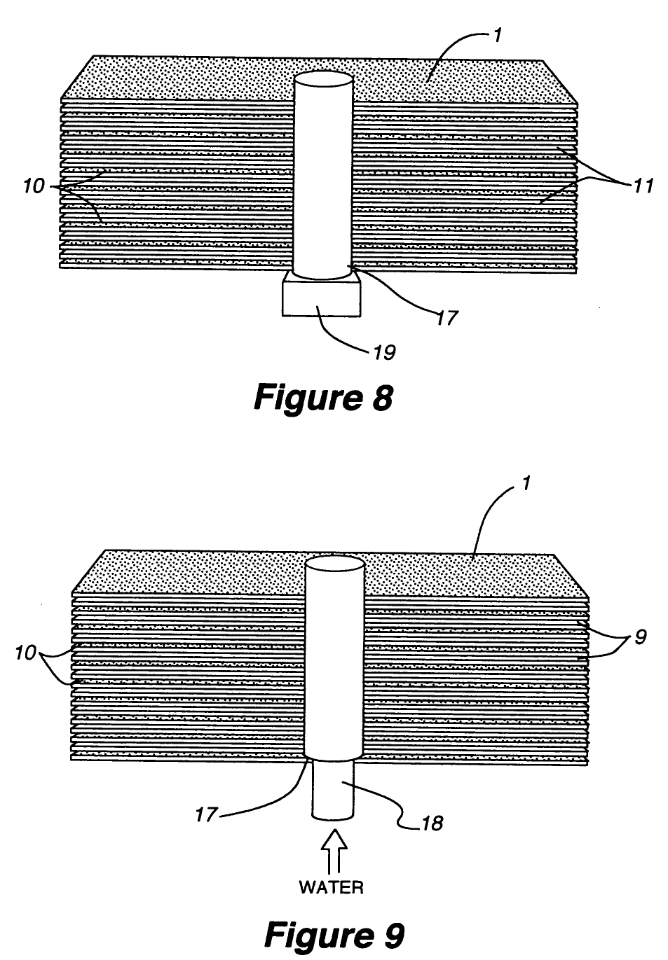

In the assembly as shown in FIG. 6, the guides and spacing function may be by intermediate corrugated sheets between the component plates. An intermediate corrugated sheet will occur between the plates, as illustrated in FIG. 6. This gives the benefit of corrugated channel guides (8). The corrugated channel sheet in the embodiments as illustrated is comprised of a low permeability material such as plastic, with the sufficient structure stiffness to keep the separation and to provide the channels. This aids in the passage of air or other fluid and also helps in the heat transfer capability of the overall assembly. By limiting the water or fluid uptake capability of this corrugated sheet, the fluids are relegated to the wick layers on the perimeter of the air channels. This is where the heat transfer occurs. By keeping the fluid content at this location it enhances the heat transfer between the product air (15) and working air (16) and across the interface of the wick plastic interface (3) of the plate.

Further refinements are illustrated in FIG. 3 and show that some product air (15) is being directed back into the working air inlet (16).

The advantage of recycling some of the cool product air into the working air is apparent when it is understood that the product air has not had moisture added. The product air has been cooled in passing through the product channel by way of heat transfer across the plastic layers (3).

The recycle of product air that is redirected into the working air produces added cooling and lower final product temperatures. This recycling of the product air gains the advantage that it reduces the working air temperature which in turn reduces the product temperature. The amount of product air that is redirected affects the stability and to what temperature the product air can be lowered.

An alternative to that illustrated in FIG. 3 would be to have successive layers of plates with the product air channel such as the air from the first product channel in the assembly sheet of the FIG. 3 redirected as the working air in the second channel for working air. This will then cause the working air channel to be at or below the temperature of the product air coming out of the first product air channel. Then the heat transfer that occurs between the second working channel and the second product channel will create a cooler temperature in the second product channel. Thus, its same cycling may be done again as many times as desired. Thus the second product channel may be redirected and become the third working air channel and because it starts at a lower temperature than the first working air channel the result in the third air channel will be lower than the first or second product air. The idea is that lower and lower temperatures will be obtained up to some maximum approaching the dew point temperature of the ambient air.

Mineral deposit build-up caused by the naturally occurring dissolved minerals in water is significantly reduced by the geometry of the plates. Experiments have shown that by placing a plastic backing on the wick, deposit build-up is reduced by half on the exposed side of the wick. Air blowing across a plastic coated wick will only form deposits along the edge. If the humidity level is high, the deposits are less likely to form. The plastic coated plates with wick sides together and air moving between forms this desired environment to reduce or prevent mineral deposit build-up. The ability to prevent mineral build up also is improved if the plates are near horizontal as the wicking will be better and the minerals will be suspended. The minerals can then migrate within the wet layer to areas of lower concentration.

The transportation and supply of fluids or water to the wick layers of the composite sheets (1) is another area of improvement encompassed within the subject invention. Water, as an example, has surface tension when it is pooled or in droplets. This is created by the polarity of the molecules. When the molecules are not aggregated in large concentration, the surface tension is less. Surface tension inhibits evaporation and thus would inhibit the efficiency of the evaporative cooler. Thus for this design criteria it is best to not allow the water to form droplets or pools. One method of preventing this is to allow the fluid in the wick layer of the composite sheeting (1) to move to the appropriate location by a wicking mechanism rather than surface flow. The wicking allows a replenishment of what moisture may have evaporated only to the amount necessary in equilibrium with the surrounding fiber. This minimizes the pooling of fluids thus minimizing the surface tension and enhances the evaporation mechanics. It also prevents over wetting which can deteriorate the efficiency of an evaporative cooler, by cooling water rather than air.

Wicking can occur but can be inhibited by physical constraints such as gravity, plate orientation, and by the length of the path of wicking. In circumstances of a plate being elevated on one side above the source of the water the wicking may allow only a partial wetting of the plate. Additionally if the wicking occurs over a long distance with evaporation occurring throughout, there may be circumstances where moisture will not adequately reach the far end of the fiber material. To address this shortcoming additional feeder wicks (17) may be necessary to ensure adequate supply water throughout the entire structure and assembly and throughout all of the layers at a disparate location in the assembly. In many installations, the feeder wick may be the only source of water.

The preferred embodiment of the feeder wick (17), shown in FIG. 9, involves a water distribution tube (18) which carries water or fluid to the location. At the location and before this tube interfaces with the fiber layers of the sheets (1) the water distribution tube (18) is wrapped with the feeder wick material (17). The material of the feeder wick may be formed in any way around the water distribution tube. The outer edge of the feeder wick (17) interfaces and touches at its outer edge the inner edge of holes that have been formed in the composite plates (1). Water or other fluid for evaporation, is fed to the distribution tube. Through holes such as large holes or by weep holes the fluid is allowed to exit the transportation tube and contact the feeder wick on the inside surface. As the fluid enters the feeder wick it wicks throughout the feeder wick to the outer surface which is in contact with the edge of the hole of each of the composite plates (1).

The weep holes or other holes may be in an upper end of the feeder wick assembly such that it exits the transport tube at the upper end of the feeder wick and through gravity drops the length of the feeder material (17). Alternately, with the wick may be resting in or having available a fluid reservoir (19). The fluid is wicked throughout the length of the feeder wick, to then come in contact with the holes in successive layers of the composite plates. The fluid is distributed through the feeder wick to each of the layers of the composite plates to ensure adequate moisture and fluid to be available for the evaporative cooling and heat transfer.

1. An indirect evaporative cooling assembly that also operates as a heat exchanger comprising:
a plurality of parallel, spaced apart, thin, nonstructural plates without the ability to retain their formed shape without support when wet, each having two surfaces, wherein—
(a) the first surface of each plate forms at least partially a wet side, wherein the wet side is wetted with evaporative fluid which cools the wet side as it evaporates,
(b) the second surface of each plate forms at least partially a dry side, wherein the dry side is fabricated with a low permeable material operating as a heat exchanger, and
(c) opposing surfaces of adjacent plates have like sides; and
elongated channel guides disposed between the plates and connecting the plates, the channel guides providing structure to the assembly and support to the nonstructural plates, the channel guides positioned to guide fluids between adjacent plates, wherein channel guides between wet sides are not parallel to channel guides between dry sides.

2. The assembly of claim 1, wherein the plates are spaced apart between 1.5 mm and 3.5 mm.

3. The assembly of claim 1, wherein the plates are spaced apart between 1.5 mm and 1.85 mm.

4. The assembly of claim 1, wherein the plates are spaced apart between 2.0 mm and 2.35 mm.

5. The assembly of claim 1, wherein the plates are spaced apart between 2.1 mm and 2.9 mm.

6. The assembly of claim 1, wherein the plates are spaced apart between 3.1 mm and 3.5 mm.

7. The assembly of claim 1 wherein the wet sides are fabricated with a plate wicking material for holding and distributing the evaporative fluid.

8. The assembly of claim 7 wherein the plate wicking material is selected from among the following materials: cellulose, polyester, polypropylene, or fiberglass.

9. The assembly of claim 7 further comprising feeder wicks, wherein the feeder wicks are constructed and arranged to provide the evaporative fluid for the wet sides.

10. The assembly of claim 9 wherein each feeder wick comprises:
a tube to carry the evaporative fluid;
a feeder wick material covering a portion of the outside of the tube; and
passageways for allowing the evaporative fluid to pass from the inside of the tube to the outside of the tube; and
wherein the feeder wick material interfaces with the edge of a plate to transfer the evaporative fluid from the feeder wick to the plate.

11. The assembly of claim 7 wherein the plates are in near horizontal orientation, thus allowing minerals concentrated from the evaporation of evaporation fluid to move from areas of higher concentration to areas of lower concentration.

12. The assembly of claim 1, further including means for passing air over the wet sides to evaporate the evaporative liquid.

13. The assembly of claim 12 wherein the evaporative fluid is water.

14. The assembly of claim 12, further including means for introducing a product to the dry sides such that the product is cooled by the dry sides.
